(19) United States
(12) Patent Application Publication
(10) Pub. No.: US 2019/0294478 A1
(43) Pub. Date: Sep. 26, 2019

(54) METHOD FOR VALIDATING VALIDITY OF GROUP MEMBER OF VIRTUAL RESOURCE

(71) Applicant: KOREA ELECTRONICS TECHNOLOGY INSTITUTE, Seongnam-si, Gyeonggi-do (KR)

(72) Inventors: Seung Myeong JEONG, Seongnam-si, Gyeonggido (KR); Il Yeup AHN, Yongin-si, Gyeonggi-do (KR); Jae Ho KIM, Seongnam-si, Gyeonggi-do (KR); Sung Chan CHOI, Seoul (KR); Nak Myoung SUNG, Gwangju-si, Gyeonggi-do (KR); Jae Seok YUN, Yongin-si, Gyeonggi-do (KR)

(21) Appl. No.: 16/316,577

(22) PCT Filed: Mar. 23, 2017
(86) PCT No.: PCT/KR2017/003141

§ 371 Date: Jan. 9, 2019

(30) Foreign Application Priority Data
Jul. 9, 2016 (KR) 10-2016-0087194
Nov. 9, 2016 (KR) 10-2016-0148536

(51) Int. Cl. G06F 9/50

(52) U.S. Cl. CPC G06F 9/5077

(57) ABSTRACT

A method for validating the validity of a group member of a virtual resource is provided. A method for validating the validity of a group according to an embodiment of the present invention obtains parent resource type information of a resource designated by a group member ID included in a group generation request and validates the validity of the group by using the obtained parent resource information. Accordingly, the validity of a virtual resource as a group member can be validated.

### TECHNICAL FIELD

The present disclosure relates to machine to machine (M2M)/Intent of Things (IoT) technology, and more particularly, to a method for validating validity of a group member to be included in a group resource.

### BACKGROUND ART

FIG. 1 is a view provided to explain a group resource. FIG. 1 illustrates that a “group1” resource is generated as a group resource.

The “group1” resource includes a <fanOutPoint> resource. The <fanOutPoint> resource is a virtual resource which can be regarded as a kind of a function only for execution of a function, and does not include any information or data as well as an attribute.

As shown in FIG. 1, the <fanOutPoint> resource sends a fanned-out request from an originator device to a “/CSE02/base1/res2” resource and a “/CSE03/base1/res3” resource, which are members of the “group1” resource, and collects responses thereto and delivers the responses to the original device.

FIG. 2 is a view provided to explain a related-art method for a group member validation. In FIG. 2, it is assumed that an originator device requests creation of a “group 1” resource, and designates “container” as the member type, and designates “/CSE02/base1/res2” and “/CSE03/base1/res3” as the memberIDs.

A group hosting CSE may retrieve resources of “/CSE02/base1/res2” and “/CSE03/base1/res3”, and may grasp the resource types in order to validate validity of members that the original device intends to include in the group. In addition, the resource type may be grasped by partially retrieving only a resource type attribute rather than retrieving all resources.

As shown in FIG. 2, the grasped resource type of the group members will be “container,” and it is identical to the memberType, “container,” recorded on the group creation request, and accordingly, the validation of the group validity succeeds.

FIG. 3 is a view provided to explain problems when validity of a group member is validated in the related-art method. In FIG. 3, it is assumed that an originator device requests creation of a “group1” resource, and designates “latest” as a member type, and designates “/CSE02/base1/cnt/latest” as a member ID.

The <latest> resource is a virtual resource which performs a function of returning a <contentInstance> resource, which is created lastly among children resources of a parent <container> resource when receiving a retrieve request.

Since the <latest> resource is a virtual resource like the above-described <fanOutPoint> resource, the <latest> resource does not contain information regarding a type thereof.

In addition, since the <latest> resource refers to the <contentInstance> resource which is created lastly among the <contentInstance> resources having a sibling relationship therewith, a group hosting CSE retrieves the “/CSE02/base1/cnt/latest” resource, but does not identify the type of the <latest> resource as a resource type, but “contentInstance” which is a resource type of “inst9” that the <latest> resource refers to.

Accordingly, the related-art method cannot validate validity of a virtual resource as a group member.

### DISCLOSURE

### Technical Problem

The present disclosure has been developed in order to address the above-discussed deficiencies of the prior art, and an object of the present disclosure is to provide a method for validating validity of a virtual resource as a group member.

### Technical Solution

According to an embodiment of the present disclosure to achieve the above-described objects, a method for a group member validation includes the steps of: checking a type attribute of a parent resource of a member resource to be included in a group; and determining validity as a member of the group based on a result of the checking.

The step of checking may be performed when the member is a resource that does not contain type information.

In addition, the step of checking may be performed when the member is a virtual resource.

In addition, the virtual resource may be addressed by appending a resource name of the virtual resource to a resource ID of the parent resource.

In addition, a resource name of the virtual resource may be pre-defined.

In addition, the parent resource of the virtual resource may be limited to a pre-defined resource type.

In addition, the virtual resource may include at least one of a latest resource which, when there is a request, applies the request to a latest resource among existing resources, and an oldest resource which, when there is a request, applies the request to an oldest resource among existing resources.

The step of checking may further include a first checking step of checking whether the type of the parent resource is able to have the virtual resource as a child.

In addition, the step of checking may further include a second checking step of checking whether a type of the virtual resource matches with a member type of the group.

According to an embodiment of the present disclosure, the method may further include a step of, when the member to be included in the group is a normal resource, checking a type attribute of the normal resource and determining validity as a member of the group.

The step of checking may be performed in a group creation procedure.

In addition, the step of checking may be performed in a group update procedure.

According to another embodiment of the present disclosure, an electronic device may include: a processor configured to check a type attribute of a parent resource of a member to be included in a group, and to determine validity of the member as a member of the group based on a result of the checking; and a storage configured to provide a storage space necessary for the processor.

In addition, the processor may be operated when the member is a virtual resource.

In addition, the processor may be configured to, when a type of the parent resource is determined to be able to have the virtual resource as a child, check whether a type of the virtual resource matches with a member type of the group, and to determine validity.

### Advantageous Effects

According to embodiments of the present disclosure as described above, validity of a virtual resource as a group member can be validated. Accordingly, a virtual resource can be formed as a group based on validation of validity of a virtual resource which is not currently supported, and may be used.

### DESCRIPTION OF DRAWINGS

FIG. 1 is a view provided to explain a virtual resource;

FIG. 2 is a view provided to explain a related-art method for a group member validation;

FIG. 3 is another view provided to explain the related-art method for validating validity of the group member;

FIG. 4 is a view provided to explain a method for a group member validation according to an embodiment of the present disclosure;

FIG. 5 is a flowchart provided to explain a method for a group member validation according to an embodiment of the present disclosure;

FIG. 6 is a view illustrating an M2M/IoT system to which the present disclosure is applicable; and

FIG. 7 is a block diagram of an interior of each electronic device shown in FIG. 6.

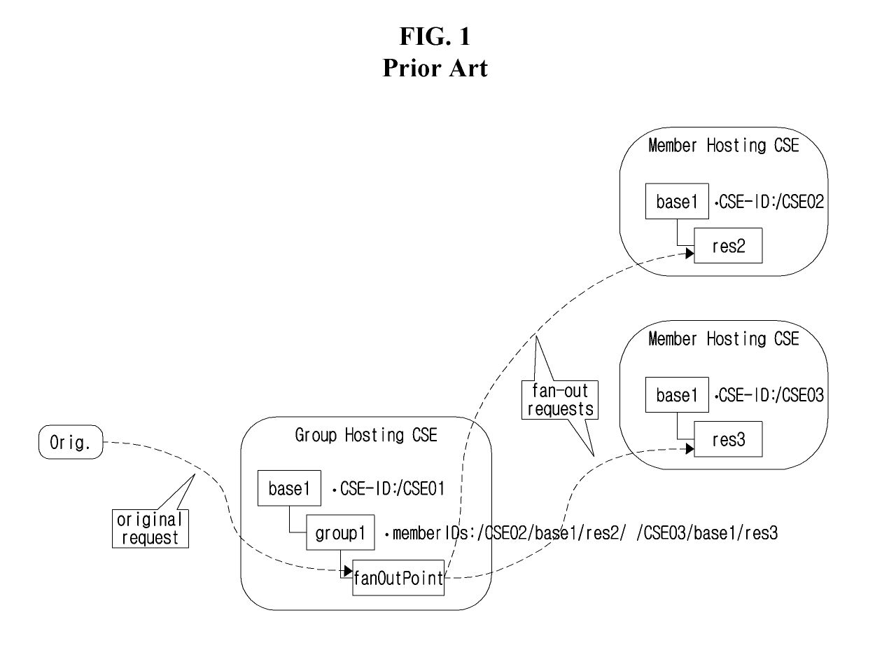

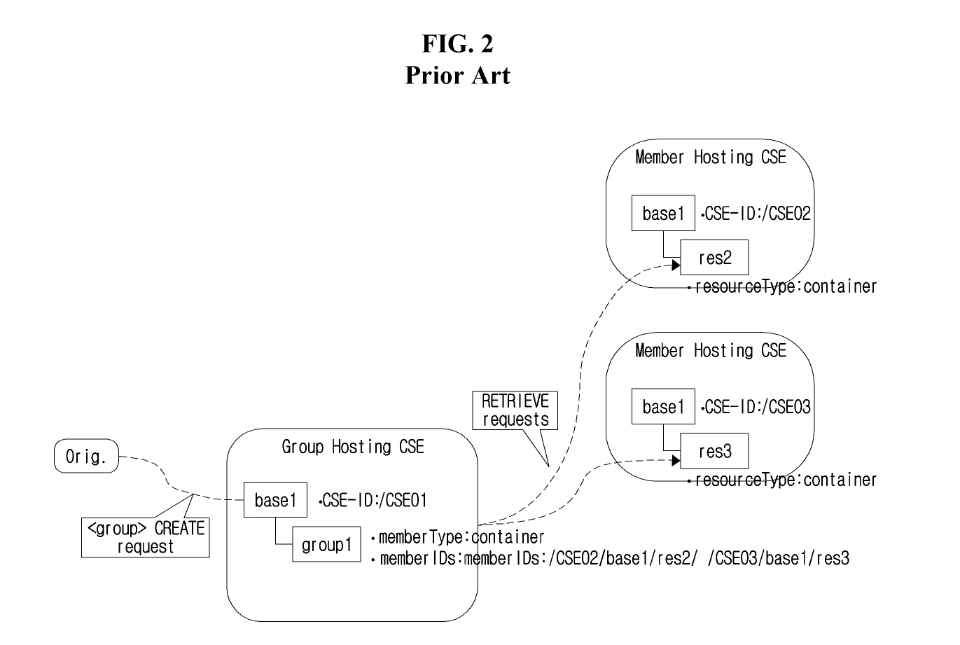

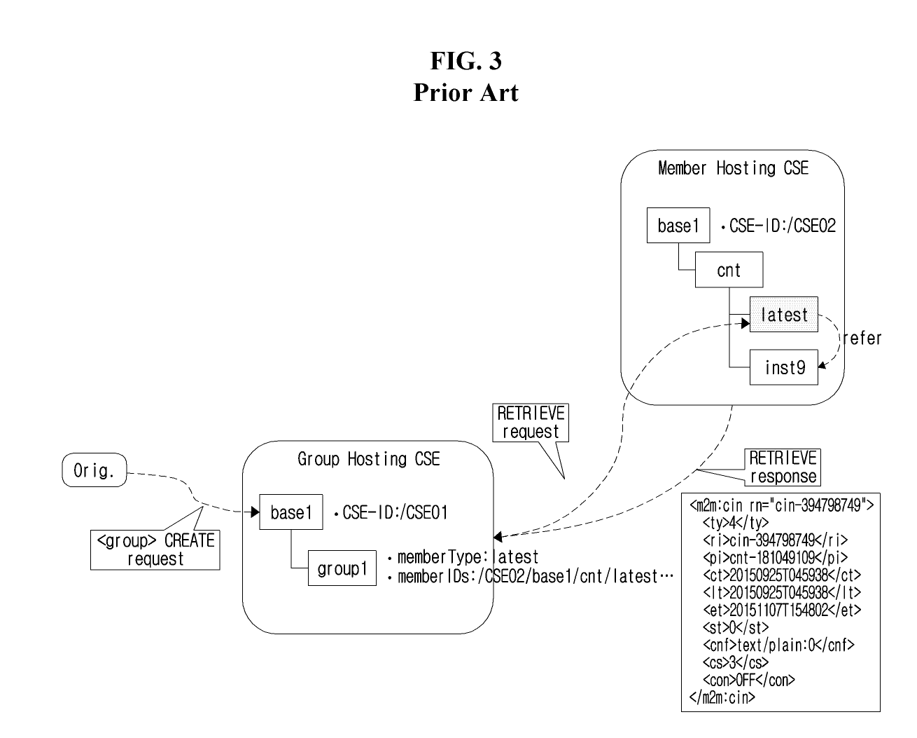

### BEST MODE

Hereinafter, the present disclosure will be described in more detail with reference to the drawings.

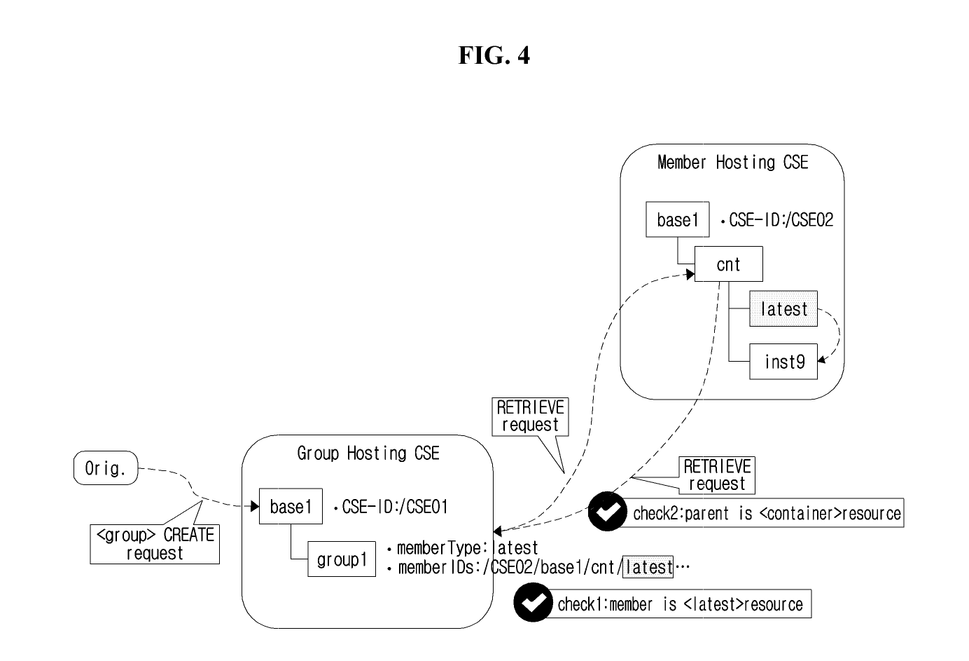

FIG. 4 is a view provided to explain a method for a group member validation according to an embodiment of the present disclosure.

The method for a group member validation according to an embodiment of the present disclosure suggests a technique for validating validity of a virtual resource when the virtual resource is intended to be included as a group member.

In FIG. 4, it is assumed that an originator device requests creation of a “group1” resource, and designates “latest” as a member type, and a member ID list (displayed as “memberIDs” in FIG. 4) includes “/CSE02/base1/cnt/latest” which is an identifier of a virtual resource.

A group hosting CSE may guess whether a member that the originator device intends to include in the group is a virtual resource or a normal resource, based on the member ID list. The member ID list includes IDs of member resources. When the member is a virtual resource, the resource ID (or resource address) is defined by appending a “/” followed by the name of the virtual resource after the ID of the parent resource.

The virtual resource does not define a procedure of generating an instance unlike a normal resource, and thus cannot be assigned a resource name separately according to a request of a device and an application, and uses a pre-defined virtual resource type name as its virtual resource name. Accordingly, the virtual resource name and the virtual resource type (name) used in embodiments of the present disclosure may be regarded as being the same. Since the virtual resource is automatically and virtually created when the parent resource is created, the parent resource of the virtual resource cannot create a normal child resource of the same name as the name of the virtual resource (or type name of the virtual resource).

In the above-described example, the member type of the group resource is <latest>, and the first member ID ends with “latest.” Accordingly, the group hosting CSE should check whether the “/CSE02/base1/cnt/latest” resource of the present member that the originator device intends to include in the group is a virtual resource of a real <latest> type, or a resource instance of a different type named “latest.”

In the case of a normal resource, type information of the resource may be directly identified through a resourceType attribute value of the corresponding resource. However, in the case of a virtual resource, type information of the virtual resource cannot be directly identified since the virtual resource does not have any attribute value. For example, in the above-described example, when the group hosting CSE retrieves information to identify the type of the “/CSE02/base1/cnt/latest” resource, a certain <contentInstance> resource indicated by the virtual resource may be returned on the assumption that the resource is the resource of the real <latest> type, and the resource type may be misunderstood as the <contentInstance> resource type.

Accordingly, in an embodiment of the present disclosure, type information of a virtual resource is identified by identifying the name of the virtual resource and type information of the parent resource, by using a relationship that a specific virtual resource is automatically created as a resource of a specific normal resource, and has its name pre-defined as a resource type name.

Accordingly, in the case illustrated in FIG. 4, the “/CSE02/base1/cnt/latest” resource is indicated by “latest.” Therefore, when it is checked that the “/CSE02/base1/cnt” resource, which is the parent resource of “latest,” is a resource of a <container> type, it may be identified that the “/CSE02/base1/cnt/latest” is the resource of the real <latest> type. This is because the <container> resource (expressed by the “cnt” resource in FIG. 4) has always a child virtual resource named “latest” when being created as an instance.

An additional reason why the type of the parent resource should be identified when the type information of the virtual resource is identified is that the parent resource may create a resource named “latest” even if the parent resource is not the resource of the <container> type. For example, when a <CSEBase> resource has a resource of an <AE> type as a child, the <AE> type may use “latest” as a name.

Accordingly, when the name of the virtual resource (or type name of the virtual resource) is included as a member ID, the group hosting CSE may identify the type of the parent resource of the corresponding resource, and may validate whether the type of the parent resource can have the virtual resource as a child. When the validation succeeds, the group hosting CSE may identify that the resource indicated by the corresponding member ID is the virtual resource of the type indicated by the corresponding name. In addition, the group hosting CSE may validate validity of the group resource including the virtual resource member, by identifying that the resource type of the corresponding member is the same as the member type (memberType attribute) recorded on the group creation request.

As an alternative method to the above-described method of validating the type of the virtual resource, there may be a method by which type information of a resource which indicates <contentInstance> as a group member type, and is indicated by a member ID is retrieved in the same way as a related-art normal resource, and, when the type information is the <latest> type, the type of the resource is recognized as the <contentInstance> type. However, in the case of a group in which a certain member has the <latest> resource and another member has the <oldest> resource, both members may be determined to have the <contentInstance> type. Therefore, there is a problem that the group hosting CSE cannot distinguish between the two types when checking validity. Since a specific application may require the oldest information and the latest information, simultaneously, according to a service, the present alternative which cannot distinguish between the two resource types cannot be applied.

As another alternative method, a method of creating <container> resources, which are parent resources, as a group, rather than creating child resources such as <latest> resources as a group, may be considered. For example, when member 1 is “cnt1/latest” and member 2 is “cnt2/latest,” “cnt1” and “cnt2” rather than “latest” are formed as a group. Then, when the originator sends an address of a child resource, applied to the respective members in common, to an address performing fan-out like “/CSE02/grp2/fanOutPoint/latest,” to access the respective <latest> virtual resources at a time, the group hosting CSE sends the fanned-out request to “cnt1/latest” and “cnt2/latest.” However, this method appends the address “/latest,” following the “fanOutPoint” of the original request message as shown in the above-described example, after the member resource address “cnt1,” “cnt2.” Therefore, only when all member resources have the same name (the same resource type in the case of a virtual resource), this method is limitedly applied. That is, when other virtual resources than <latest> or normal resources are grouped to one group, validity of the group cannot be validated.

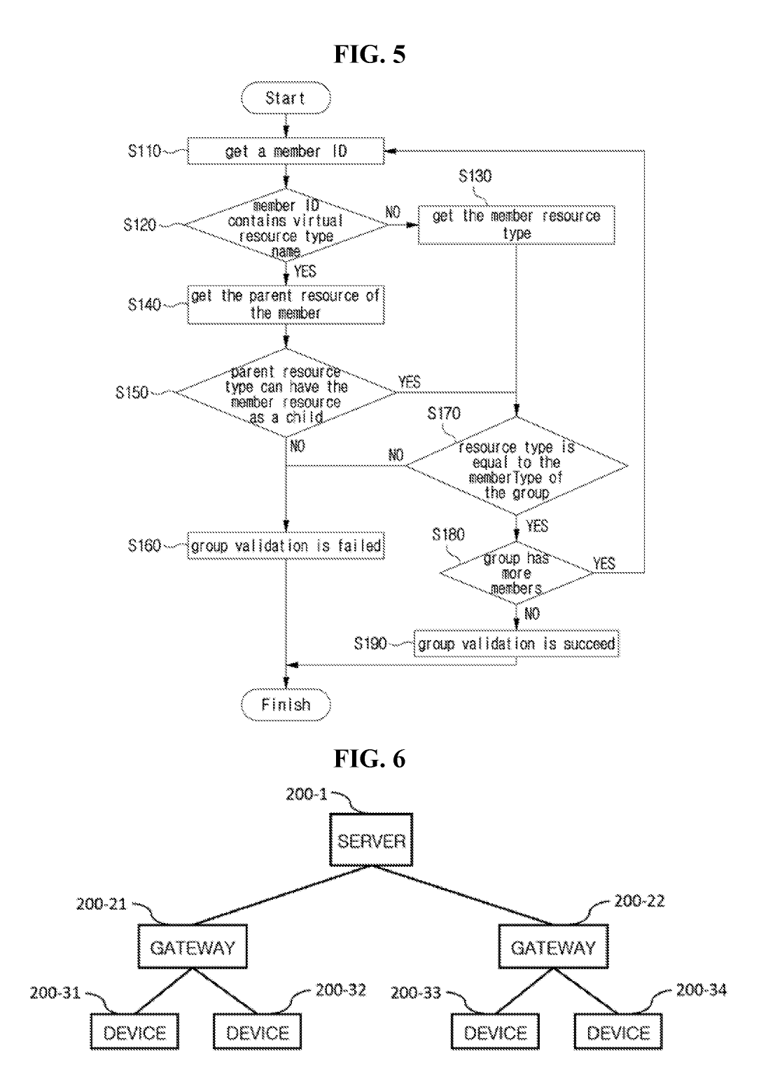

FIG. 5 is a flowchart provided to explain a method for a group member validation according to an embodiment of the present disclosure.

As shown in FIG. 5, the group hosting CSE obtains a group member ID recorded on a group creation request received from the originator device (S110).

When the group member ID (address) obtained in step S110 contains a virtual resource type name at the end thereof (S120—Yes), the group hosting CSE retrieves type information of a parent resource of the resource which is designated as the group member (S140).

When it is validated that the parent resource type grasped in step S140 can contain the virtual resource grasped in step 120 (S150—Yes), the group hosting CSE may check whether the group member type recorded on the group creation request received from the originator device is identical to the virtual resource type grasped in step S120, and validates validity of the group member (S170).

Step S150 corresponds to a procedure for checking whether the parent resource grasped in step S140 can have the virtual resource grasped in step S120 as a child. This is because the parent resource type of the virtual resource is limited to a pre-defined specific resource type.

In addition, step S170 corresponds to a procedure for checking whether the virtual resource type grasped in step S120 is identical to the group member type recorded on the group creation request.

When it is checked that the group member type is not identical to the virtual resource type (S170—No), the group validation fails (S160). In addition, when it is checked that the parent resource type grasped in step S140 cannot contain the virtual resource grasped in step S120 (S150—No), the group validation fails (S160).

On the other hand, when the group member ID obtained in step S110 does not contain the virtual resource type name, that is, when the group members are all normal resources (S120—No), the group hosting CSE retrieves type information of the resource directly designated from the group member resource (S130), and may validate validity of the group member by checking whether the group member type recorded on the group creation request received from the originator device is identical to the type grasped in step S130 (S170).

The validity of the normal resource is validated as a group member by checking a type attribute of the resource designated as the group member, rather than checking a type attribute of the parent resource. Therefore, there is a difference from the virtual resource the validity of which is validated by using the type attribute of the parent resource.

When the validation of the group member does not fail, steps S110 to S190 are repeated until these steps are performed for all of the group member IDs recorded on the group creation request (S180), and, when validation of all of the group member IDs succeeds (S180—No), the validation of the group succeeds (S190).

On the other hand, when only one group member ID is not validated, the validation of the group fails (S160).

The method for validating validity of the group member of the virtual resource has been described in detail up to now with reference to preferred embodiments.

The <latest> resource mentioned in the above-described embodiment is a resource indicating a function which, when there is a request, applies the request to the latest <contentInstance> resource from among <contentInstance> resources existing with a sibling relationship therewith as a child resource of the parent <container> resource, and is mentioned as one of the virtual resources, which are a kind of resource not containing type information of the resource. The technical idea of the present disclosure can be applied to virtual resources of other types that do not contain type information, for example, an <oldest> resource which, when there is a request, applies the request to the oldest <contentInstance> resource from among the <contentInstance> resources existing with a sibling relationship therewith as a child resource of the parent <container> resource, and other <fanOutPoint> resource, a <semanticFanOutPoint> resource, a <pollingChannelURI> resource, a <notificationTargetSelfReference> resource, or the like.

Furthermore, the technical idea of the present disclosure can be applied to a resource of any type only if the resource does not contain type information, although the resource performs the same function as the virtual resource, but is a different resource having a different name, or the resource is not the virtual resource.

That is, in validating validity of a member to be included in a group, the technical idea of the present disclosure can be applied to a method of referring to the type attribute of the parent resource rather than the member.

The process of checking validity of the virtual resource, which is used when the <group> resource is created in the above-described embodiment, may be equally used for a case where a member ID list is changed when the <group> resource is updated.

In addition, a structured resource ID (hierarchical address) is mentioned as a resource ID, a group ID in the above-described embodiment. However, this is merely an example. The technical idea of the present disclosure can be applied to a case in which a resource ID is designated/used as an unstructured resource ID (nonhierarchical address).

In addition, a structured resource ID (hierarchical resource ID) is mentioned as a resource ID, a group ID in the above-described embodiment. However, this means that a resource name on a resource tree is a continuous connection of names from a top level to a corresponding resource by using “/.” This is merely an example. In another example, the present disclosure can be equally applied to a case in which an unstructured resource ID (nonhierarchical resource ID) and a resource name(s) are mixed. In the case of the “/CSE02/base1/cnt/latest” resource ID as in the above-described example, when the nonhierarchical resource ID, called “cnt,” is “res123,” the same resource may be indicated by “/CSE02/res123/latest.” In this case, according to the method of the present disclosure, the “/CSE02/res123” resource may be obtained and it may be checked whether this resource is a <container> type or not.

FIG. 6 is a view illustrating an M2M/IoT system to which the present disclosure is applicable. The M2M/IoT system to which the present disclosure is applicable is established by connecting various electronic devices, such as a server 200-1, a gateway 200-21, 200-22, a device 200-31, 300-32, 200-33, 200-34, to communicate with one another, as shown in FIG. 6.

The number of the electronic devices illustrated in FIG. 6, that is, the number of servers 200-1 constituting the M2M/IoT system, is merely an example. Therefore, the technical idea of the present disclosure can be applied to other cases.

Furthermore, the connection structure of the electronic devices illustrated in FIG. 6 may also be replaced with other structures when necessary.

All of the electronic devices illustrated in FIG. 6 may create and update a resource group. That is, all of the server 200-1, the gateway 200-21, 200-22, and the device 200-31, 200-32, 200-33, 200-34 may create/update a resource group. In this process, these devices validate validity of a group member according to the flowchart illustrated in FIG. 5.

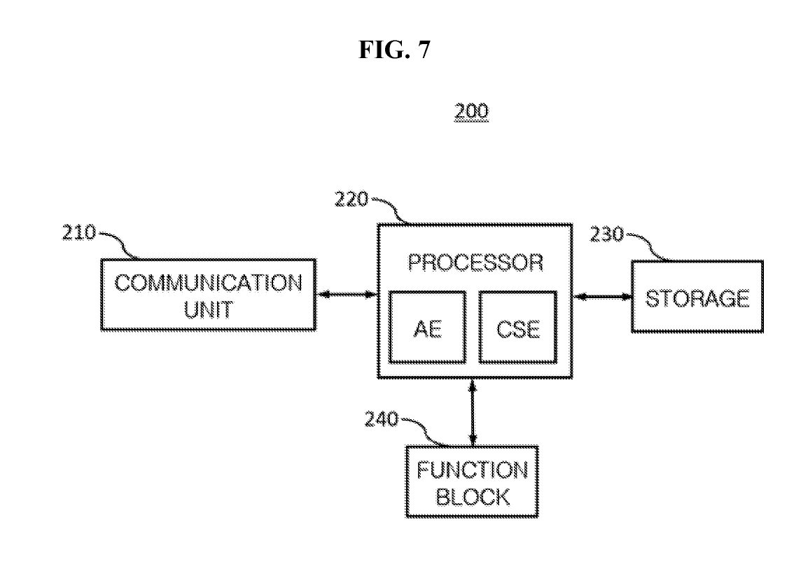

FIG. 7 is a block diagram of an interior of each electronic device illustrated in FIG. 6. Elements necessary for implementing embodiments of the present disclosure are all common to the server 200-1, the gateway 200-21, 200-22, the device 200-31, 200-32, 200-33, 200-34. Accordingly, these devices are indicated by reference numeral “200” in FIG. 7, and will be referred to as an electronic device.

As shown in FIG. 7, the electronic device according to another embodiment of the present disclosure includes a communication unit 210, a processor 220, a storage 230, and a function block 240.

The communication unit 210 is a communication interface means for communicating with an external device and for accessing an external network.

The processor 220 includes at least one application entity (AE) and a common service entity (CSE). The AI may not be included according to a type and a function of the electronic device.

The CSE of the processor 220 may create/update a resource group, and in this process, validates validity of a member according to the algorithm illustrated in FIG. 5.

The storage 230 provides a storage space necessary for the processor 220 to perform an operation, for example, to create/update a resource group and to validate validity of a member.

The function block 240 performs an original function of the electronic device. For example, when the electronic device is the device 200-31, 200-32, 200-33, 200-34, a sensor and/or an actuator may correspond to the function block 240.

The technical idea of the present disclosure may be applied to a computer-readable recording medium which records a computer program for performing the functions of the apparatus and the method according to the present embodiment. In addition, the technical idea according to various embodiments of the present disclosure may be implemented in the form of a computer-readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer-readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

1. A method for a group member validation, the method comprising the steps of:
checking a type attribute of a parent resource of a member to be included in a group; and
determining validity as a member of the group based on a result of the checking.

2. The method of claim 1, wherein the step of checking is performed when the member is a resource that does not contain type information.

3. The method of claim 1, wherein the step of checking is performed when the member is a virtual resource.

4. The method of claim 3, wherein the virtual resource is addressed by appending a resource name of the virtual resource to a resource ID of the parent resource.

5. The method of claim 3, wherein a resource name of the virtual resource is pre-defined.

6. The method of claim 3, wherein the parent resource of the virtual resource is limited to a pre-defined resource type.

7. The method of claim 3, wherein the virtual resource comprises at least one of a latest resource which, when there is a request, applies the request to a latest resource among existing resources, and an oldest resource which, when there is a request, applies the request to an oldest resource among existing resources.

8. The method of claim 3, wherein the step of checking further comprises a first checking step of checking whether a type of the parent resource is able to have the virtual resource as a child.

9. The method of claim 8, wherein the step of checking further comprises a second checking step of checking whether a type of the virtual resource matches with a member type of the group.

10. The method of claim 3, further comprising a step of, when the member to be included in the group is a normal resource, checking a type attribute of the normal resource and determining validity as a member of the group.

11. The method of claim 1, wherein the step of checking is performed in a group creation procedure.

12. The method of claim 1, wherein the step of checking is performed in a group updating procedure.

13. An electronic device comprising:
a processor configured to check a type attribute of a parent resource of a member to be included in a group, and to determine validity of the member as a member of the group based on a result of the checking; and
a storage configured to provide a storage space necessary for the processor.

14. The electronic device of claim 13, wherein the processor is operated when the member is a virtual resource.

15. The electronic device of claim 14, wherein the processor is configured to, when a type of the parent resource is determined to be able to have the virtual resource as a child, check whether a type of the virtual resource matches with a member type of the group, and to determine validity.
